(19) United States
(12) Patent Application Publication
(10) Pub. No.: US 2010/0148677 A1
(43) Pub. Date: Jun. 17, 2010

(54) TIME DIVISION LIGHT OUTPUT SENSING AND BRIGHTNESS ADJUSTMENT FOR DIFFERENT SPECTRA OF LIGHT EMITTING DIODES

(76) Inventor: John L. Melanson, Austin, TX (US)

Correspondence Address: HAMILTON & TERRILE, LLP, PO BOX 203518, AUSTIN, TX, 78720, US

(21) Appl. No.: 12/495,185

(22) Filed: Jun. 30, 2009

Related U.S. Application Data
(60) Provisional application No. 61/122,198, filed on Dec. 12, 2008.

(51) Int. Cl. H05B 37/02

(52) U.S. Cl. 315/154

(57) ABSTRACT

In at least one embodiment, brightness multiple LEDs is adjusted by modifying power to subgroups of the multiple LEDs during different times and detecting the brightness of the LEDs during the reductions of power. In at least one embodiment, once the brightness of the LEDs are determined, a controller determines if the brightness meet target brightness values, and, if not, the controller adjusts each LED with the goal meet the target brightness values. In at least one embodiment, a process of modifying power to the subgroups of multiple LEDs over time and adjusting the brightness of the LEDs is referred as “time division and light output sensing and adjusting. Thus, in at least one embodiment, a lighting system includes time division light output sensing and adjustment for different spectrum light emitting diodes (LEDs).

### CROSS REFERENCE TO RELATED APPLICATIONS

This application claims the benefit under 35 U.S.C. §119(e) of U.S. Provisional Application No. 61/122,198, filed Dec. 12, 2008 and entitled “Single Photo-Detector for Color Balance of Multiple LED Sources”. U.S. Provisional Application No. 61/122,198 includes exemplary systems and methods and is incorporated by reference in its entirety.

### BACKGROUND OF THE INVENTION

1. Field of the Invention

The present invention relates in general to the field of lighting and signal processing, and more specifically to a system and method of time division light output sensing and adjusting the brightness of different spectra of light emitted from light emitting diodes.

2. Description of the Related Art

Light emitting diodes (LEDs) are becoming particularly attractive as main stream light sources in part because of energy savings through high efficiency light output and environmental incentives, such as the reduction of mercury. LEDs are a type of semiconductor devices and are driven by direct current. The brightness (i.e. luminous intensity) of the LED approximately varies in direct proportion to the current flowing through the LED. Thus, increasing current supplied to an LED increases the intensity of the LED and decreasing current supplied to the LED dims the LED. Current can be modified by either directly reducing the direct current level to the LEDs or by reducing the average current through duty cycle modulation.

that is noticeable by a human. Additionally, the brightness of an LED can vary over time due to factors such as age.

FIG. 1 depicts a lamp 100, and lamp 100 includes a housing 101 to enclose components of lamp 100. Lamp 100 also includes a narrow-band light sensor 102 and a controller 104 to adjust power to LED 106 in response to changes in the light output of LED 106. A “narrow-band” light sensor senses light in a narrow spectral band. For example, a narrow-band red light sensor senses red light but does not sense any other color light. In addition to LED 106, lamp 100 also includes LED 108. LED 106 and LED 108 have different spectrum. Thus, the “spectrum” of an LED refers to the wavelength or wavelengths of light emitted by the LED. Wavelengths of light determine the color of the light. Thus, the spectrum of an LED refers to the color of light emitted by the LED. For example, in one embodiment, a blue-green spectrum LED 106 emits blue-green light, and a red spectrum LED 108 emits red light. Lamp 100 receives an alternating current (AC) voltage V_{AC}_{_{—}}_{SUPPLY} from supply voltage source 110 through input terminals 112 and 113. The voltage source 110 is, for example, a public utility, and the AC supply voltage V_{AC}_{_{—}}_{SUPPLY} is, for example, a 60 Hz/110 V line voltage in the United States of America or a 50 Hz/220 V line voltage in Europe. Power control system 116 includes lamp drivers 114 and 115 that provide respective drive currents i_{LED1} and i_{LED2} to LEDs 106 and 108. Drive currents i_{LED1} and i_{LED2} are direct currents (DC). Varying the value of DC currents i_{LED1} and i_{LED2} varies the brightness of respective LEDs 106 and 108.

Controller 104 controls lamp drivers 114 and 115 to control the respective values of drive currents i_{LED1 and i}_{LED2}. Lamp drivers 114 and 115 are switching power converters. Controller 104 provides a pulse width modulated switch control signal CS₀₀ to lamp driver 114 to control a switch (not shown) of lamp driver 114, and controller 104 provides a pulse width modulated switch control signal CS₀₁ to lamp driver 115 to control a switch (not shown) of lamp driver 115. The values of drive currents i_{LED1} and i_{LED2} are proportional to the pulse width and duty cycle of respective control signals CS₀₀ and CS₀₁.

Light sensor 102 is a limited band light sensor that senses the brightness of LED 106 but is insensitive to light emitted from LED 108. The light 118 emitted by LEDs 106 and 108 reflects off the interior surface of housing 101 and propagates through diffuser 120 to generate broad spectrum light 122. Some light from LEDs 106 and 108 is reflected and/or directly transmitted to light sensor 102. Light sensor 102 senses the brightness of blue-green light from LED 106 and sends a signal SEN₀ to controller 104 that indicates the brightness of light emitted from LED 106. Controller 104 increases the drive current i_{LED1} if the brightness of LED 106 light is too low relative to a predetermined target brightness value and decreases the drive current i_{LED1} if the brightness of LED 106 light is too high relative to a predetermined target brightness value. The predetermined target brightness value is a matter of design choice.

Changes in brightness of an LED over time sometimes relate to the amount of power used by the LED over time. In at least one embodiment, the power that an LED uses over time is directly proportional to changes in brightness of the LED over time. Thus, the brightness of an LED that uses more power will likely change over time prior to any changes in brightness of a similar quality LED that uses less power. For example, LED 108 receives only a small percentage, such as 5%, of the total power provided to LEDs 106 and 108. As a result, the brightness of LED 108 is relatively unaffected over time. LED 106 receives 95% of the power, and, thus, the brightness of LED 106 will most likely change over time. Additionally, the power of the red component of light 122 is relatively small. Since the brightness of LED 108 is assumed to be approximately constant over the life of lighting system 100, no feedback is provided to controller 104 to adjust the brightness of LED 108. Thus, lighting system 100 avoids the cost of an additional light sensor, feedback circuitry, and controller complexity to sense and adjust the red light of LED 108.

FIG. 2 depicts a lighting system 200. Lighting system 200 includes an ambient light sensor 202 to facilitate light harvesting. Light harvesting involves supplementing artificial light 204 with natural light 206 and correlating adjustments in the artificial light with variations in the natural light. In at least one embodiment, “natural light” refers to light not generated artificially, i.e. by lamps, etc. In at least one embodiment, “natural light” refers to sunlight and reflected sun light. The physical location of ambient light sensor 202 is a matter of design choice. In at least one embodiment, ambient light sensor 202 is physically attached to the exterior of lamp housing 208. Location of ambient light sensor 202 on the exterior of lamp housing 208 assists in minimizing the contribution of artificial light 204 to the ambient light 206 received by light sensor 202.

Power control system 211 includes controller 210 to control power provided to light source 214 and, thus, control the brightness of artificial light 204 generated by light source 214. Controller 210 generates control signal CS₁ and provides control signal CS₁ to lamp driver 212 to control power delivered by lamp driver 212 to light source 214. The particular configuration of lamp driver 212 is a matter of design choice and, in part, depends upon the configuration of light source 214. Light source 214 can be any type of light source, such as an incandescent, fluorescent, or LED based source. Lamp driver 212 provides power to light source 214 in accordance with control signal CS₁. Ambient light sensor 202 generates sense signal SEN₁. Sense signal SEN₁ indicates the brightness of ambient light. Controller 210 causes lamp driver 212 to increase or decrease the brightness of artificial light 204 if the ambient light is respectively too low or too high.

Referring to FIGS. 1 and 2, lighting system 100 includes LEDs 106 and 108 with different spectra. Light source 214 can also include individual light sources, such as LEDs, with different spectra. Although lighting system 100 distinguishes between light sources having different spectra, lighting system 100 has a one-to-one correspondence between light sensors and light source spectrum, i.e. for a light source emitting a light at a particular color, the light sensor senses only light having that particular color. Lighting system 100 saves cost by not sensing light from LED 108 and, thus, avoids adding another light sensor. Lighting system 100 does not use a single, broad spectrum light sensor to sense light from both LED 106 and LED 108 because the broad spectrum light sensor cannot distinguish between the brightness of light from LED 106 and LED 108. Accordingly, controller 104 would not be able to detect if the brightness of LED 106 and/or LED 108 had changed over time. Thus, lighting system 100 exchanges accuracy and control of the brightness of LED 108 for lower cost. Lighting system 200 does not distinguish between light sources of different spectra and, thus, does not customize adjustments to the brightness of light sources based on the spectra of the light sources.

### SUMMARY OF THE INVENTION

In one embodiment of the present invention, an apparatus includes a controller configured to at least adjust brightness of light emitted from a first light emitting diode (LED) and adjust brightness of light emitted from a second LED, wherein, during operation of the controller, the light emitted from the first LED has a different spectrum than the light emitted from the second LED. The controller is further configured to receive a first signal indicating a brightness of received light at a first time and to receive a second signal indicating a brightness of the received light at a second time, wherein a relative contribution to the brightness from the first and second LEDs is different for the first and second times. The controller is further configured to determine the brightness of light emitted from the first LED and the brightness of light emitted from the second LED using information from the signals and adjust the brightness of the light emitted from the first LED and the brightness of the light emitted from the second LED in accordance with one or more brightness related target values.

In another embodiment of the present invention, an apparatus includes a lamp having at least a first light emitting diode (LED) and a second LED, wherein, during operation, light output of the first LED has a different spectrum than light output from the second LED. The apparatus also includes one or more sensors to sense brightness of received light. The apparatus further includes controller coupled to the lamp and the sensor. The controller is configured to at least receive a first signal from at least one of the sensors indicating a brightness of the received light at a first time. The controller is also configured to receive a second signal from at least one of the sensors indicating a brightness of the received light at a second time, wherein a relative contribution to the brightness from the first and second LEDs is different for the first and second times. The controller is further configured to determine the brightness of light emitted from the first LED and the brightness of light emitted from the second LED using information from the signals. The controller is also configured to adjust the brightness of the light emitted from the first LED and the brightness of the light emitted from the second LED in accordance with one or more brightness related target values.

In a further embodiment of the invention, a method to at least adjust brightness of light emitted from a first light emitting diode (LED) and adjust brightness of light emitted from a second LED, wherein the light emitted from the first LED has a different spectrum than the light emitted from the second LED, includes receiving a first signal indicating a brightness of received light at a first time. The method also includes receiving a second signal indicating a brightness of the received light at a second time, wherein a relative contribution to the brightness from the first and second LEDs is different for the first and second times. The method further includes determining the brightness of light emitted from the first LED and the brightness of light emitted from the second LED using information from the signals. The method also includes adjusting the brightness of the light emitted from the first LED and the brightness of the light emitted from the second LED in accordance with one or more brightness related target values.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 (labeled prior art) depicts a lighting system that includes a controller and narrow band light sensor to adjust the brightness of an LED.

FIG. 2 (labeled prior art) depicts a lighting system for light harvesting.

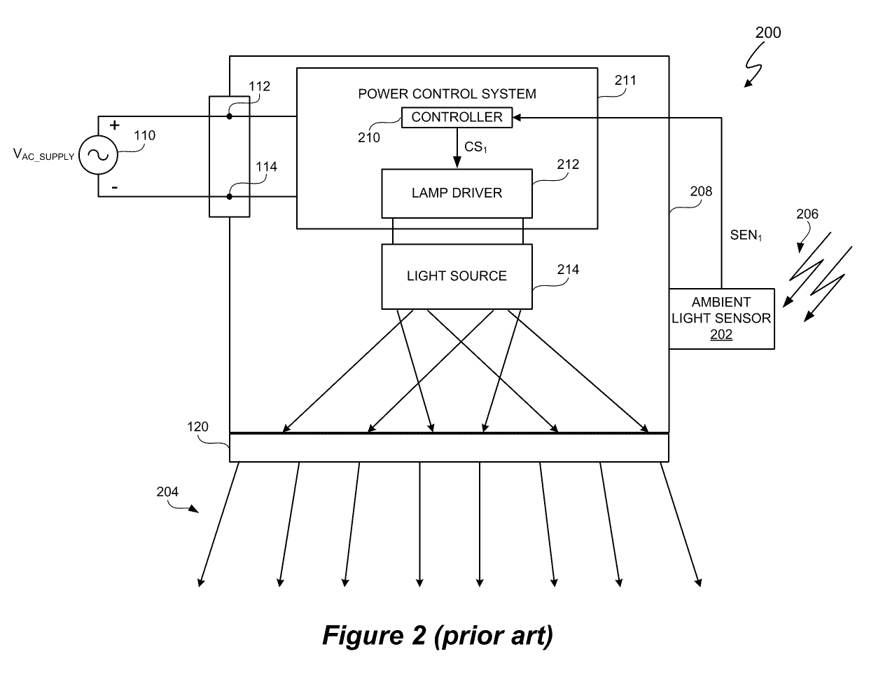

FIG. 3 depicts a lighting system with time division light output sensing and brightness adjustment for different spectrum light emitting diodes.

FIG. 4 depicts an embodiment of the lighting system of FIG. 3.

FIG. 5 depicts a time division and adjustment algorithm for sensing and adjusting the brightness of light in the lighting system of FIG. 4.

FIG. 6 depicts an LED drive current signal timing diagram which illustrates an interspacing time division for the algorithm of FIG. 5.

FIG. 7 depicts an LED drive current signal timing diagram which illustrates an interspersed time division for the algorithm of FIG. 5.

FIG. 8 depicts an LED drive current signal timing diagram which illustrates a unitary time division for the algorithm of FIG. 5.

FIG. 9 depicts another embodiment of a time division and adjustment algorithm for the lighting system of FIG. 4.

FIG. 10 depicts an embodiment of a controller of the lighting system of FIG. 3.

### DETAILED DESCRIPTION

In at least one embodiment, brightness of light emitted from multiple LEDs is adjusted by modifying power to subgroups of the multiple LEDs during different times and detecting the brightness of the LEDs during the reductions of power. In at least one embodiment, once the brightness of the LEDs are determined, a controller determines if the brightness meet target brightness values, and, if not, the controller adjusts each LED with the goal meet the target brightness values. In at least one embodiment, a process of modifying power to the subgroups of multiple LEDs over time and adjusting the brightness of the LEDs is referred as “time division and light output sensing and adjusting. Thus, in at least one embodiment, a lighting system includes time division light output sensing and adjustment for different spectrum light emitting diodes (LEDs).

In at least one embodiment, an LED set is a set of one or more LEDs whose brightness is collectively adjusted. For example, a first LED set could include four red LEDs, and a second LED set could include three blue LEDs. The brightness of each LED set can be collectively determined and adjusted. In at least one embodiment, time division light output sensing involves modulating power over time, e.g. changing current over time, to multiple LEDs to different subgroups of the LEDs. The number of LEDs in each subgroup is a matter of design choice and can be a single LED. In at least one embodiment, a controller performs time division power modulation of the LEDs by modulating power to the LEDs by selectively reducing power for a limited duration of time to a subgroup of one or more LEDs having a spectrum of interest and repeating power reductions for each LED set having spectrums of interest using a time division algorithm. The time division power modulation allows the controller to determine a relative contribution to the brightness of the light received by one or more sensors for each LED set. In at least one embodiment, a controller correlates the different brightness of received light sensed during different in accordance with the time division power modulation of the LEDs to determine the brightness of individual sets of LEDs. In at least one embodiment, a controller compares the determined brightness of individual sets of LEDs against target values and adjusts the brightness of the light emitted by the LEDs to meet the target values.

In at least one embodiment, the spectrum of light emitted by the LEDs is a matter of design choice. In at least one embodiment, the LEDs represent at least two different spectra. In at least one embodiment, the one or more sensors are photosensitive transistors and are calibrated to compensate for one or more variations in operating characteristics due to factors such as increasing operating temperatures.

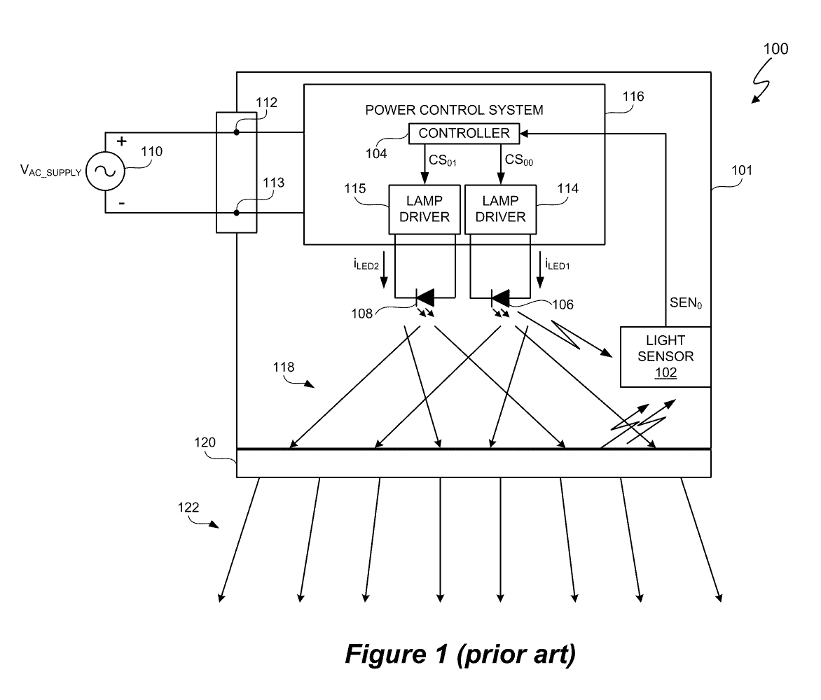

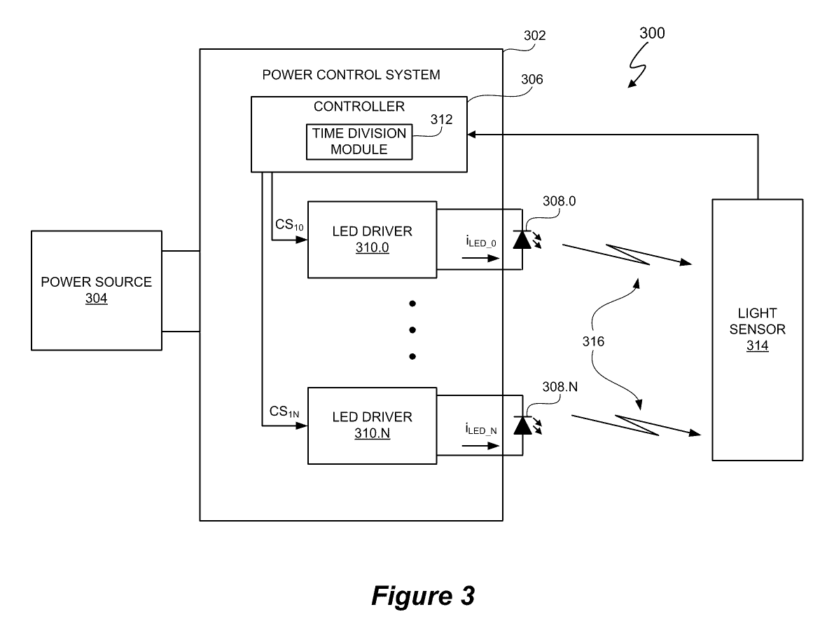

FIG. 3 depicts lighting system 300 that includes time division light output sensing and adjustment for different spectrum light emitting diodes. Lighting system 300 includes a power control system 302 that, in at least one embodiment, receives power from power source 304. In at least one embodiment, power source 304 is an external power supply, such as voltage source 110 (FIG. 1). The particular type of power source 304 is a matter of design choice.

Lighting system 300 also includes a controller 306 to control the values of N+1 LED currents i_{LED}_{_{—}}₀ through i_{LED}_{_{—}}_{N}. “N” is any integer greater than or equal to 1. The value of N depends upon the number of LED sets 308.0-308.N. Each of LED sets 308.0-308.N includes one or more LEDs. In at least one embodiment, each LED in an LED set 308 has approximately the same light spectrum. The particular spectrum is a matter of design choice and includes red, blue, amber, green, blue-green, and white. Controller 306 generates control signals CS₁₀-CS_{1N} and provides control signals to lamp drivers 310.0-310.N. In at least one embodiment, lamp drivers 310.0-310.N are switching power converters, and control signals CS₁₀-CS_{1N} are pulse-width modulated control signals. In at least one embodiment, lamp drivers 310.0-310.N are identical switching power converters, and an exemplary embodiment of a switching power converter is described in U.S. patent application Ser. No. 11/967,269, entitled Power Control System Using A Nonlinear Delta-Sigma Modulator With Nonlinear Power Conversion Process Modeling, filed on Dec. 31, 2007, inventor John L. Melanson, and assignee Cirrus Logic, Inc. U.S. patent application Ser. No. 11/967,269 is referred to herein as “Melanson I” and is hereby incorporated herein in its entirety.

Controller 306 generates control signals CS₁₀-CS_{1N} in any of a variety of ways. U.S. patent application Ser. No. 11/864,366, entitled “Time-Based Control of a System having Integration Response,” inventor John L. Melanson, Attorney Docket No. 1692-CA, and filed on Sep. 28, 2007 describes an exemplary system and method for generating a drive current control signal which can be used for driving an LED. U.S. patent application Ser. No. 11/864,366 is referred to herein as “Melanson II” and is incorporated by reference in its entirety. U.S. patent application Ser. No. 12/415,830, entitled “Primary-Side Based Control Of Secondary-Side Current For An Isolation Transformer,” inventor John L. Melanson, Attorney Docket No. 1812-IPD, and filed on Mar. 31, 2009 also describes an exemplary system and method for generating a drive current control signal which can be used for driving an LED. U.S. patent application Ser. No. 12/415,830 is referred to herein as “Melanson III” and is incorporated by reference in its entirety. In at least one embodiment, controller 306 is implemented and generates each control signal CS₁₀-CS_{1N} in the same manner as the generation of a control signal described in Melanson II or Melanson III with the exception of the operation of time division module 312 as subsequently described. Control signals CS₁₀-CS_{1N} control respective LED drive currents i_{LED}_{_{—}}₀-i_{LED}_{_{—}}_{N}. In at least one embodiment, controller 306 controls the drive currents i_{LED}_{_{—}}₀-i_{LED}_{_{—}}_{N} using linear current control.

Lighting system 300 includes a light sensor 314 to sense the brightness of light received by light sensor 314. In at least one embodiment, light sensor 314 is a single, broad spectrum light sensor that senses all the spectra of light emitted by LED sets 308.0-308.N. The physical location of light sensor 314 is a matter of design choice.

Controller 306 includes time division module 312 to, for example, selectively modulate power to LED sets 308.0-308.N to allow controller 306 to determine the brightness of at least two of the LED sets 308.0-308.N. In at least one embodiment, controller 306 decreases power to LED sets 308.0-308.N in accordance with a time division algorithm that allows controller 306 to determine the brightness of light 316 emitted from at least two of the LED sets 308.0-308.N. The controller 306 decreases power to different subgroups of the LED sets to allow the controller to determine the brightness of individual LED sets. Embodiments of the time division algorithm are discussed in more detail below.

The particular implementation of controller 306 is a matter of design choice. Controller 306 can be implemented using digital, analog, or digital and analog technology. In at least one embodiment, controller 306 is fabricated as an integrated circuit. In at least one embodiment, controller 306 includes a processor and algorithms performed by controller 306 are implemented in code and executed by the processor. The code can be stored in a memory (not shown) included in controller 306 or accessible to controller 306.

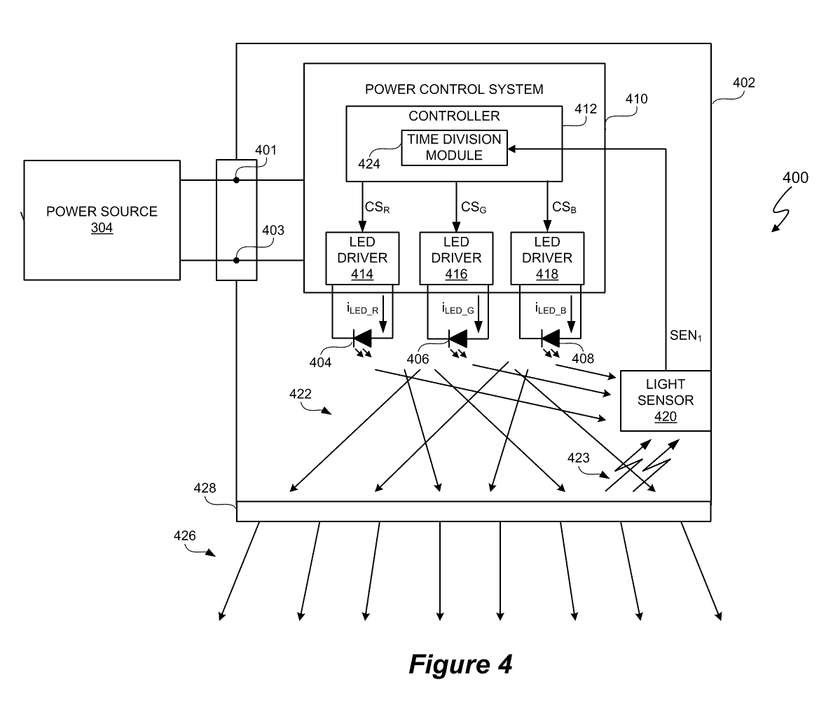

FIG. 4 depicts lighting system 400, which represents one embodiment of lighting system 300. Lamp 402 receives power from power source 304 via terminals 401 and 403. Lamp 402 includes LED 404, LED 406, and LED 408, which have different respective spectra. For purposes of description, LED 404, LED 406, and LED 408 will be discussed as respectively red, green, and blue LEDs, i.e. LED 404 emits red spectrum light, LED 406 emits green spectrum light, and LED 408 emits blue spectrum light. Lamp 402 also includes a power control system 410, which represents one embodiment of power control system 302. Power control system 410 includes controller 412 to control LED drivers 414, 416, and 418 and, thereby, control respective LED drive currents i_{LED}_{_{—}}_{R}, i_{LED}_{_{—}}_{G}, and i_{LED}_{_{—}}_{B}. In at least one embodiment, controller 412 generates control signals CS_{R}, CS_{G}, and CS_{B} in the same manner that controller 306 generates control signals CS₁₀-CS_{1N} with N=2. Controller 412 represents one embodiment of controller 306.

Lighting system 400 also includes a light sensor 420 to sense incoming light 422 from LEDs 404, 406, and 408 and ambient light 423 and generate a sense signal SEN₁. Ambient light 423 represents light that is received by light sensor 420 but not generated by LEDs 404, 406, and 408. In at least one embodiment, ambient light 423 represents light from other artificial light sources or natural light such as sunlight. In at least one embodiment, light sensor 314 is a broad spectrum sensor that senses light 422 from LEDs 404, 406, and 408 and senses ambient light 423.

The human eye generally cannot perceive a reduction in brightness from a light source if the reduction has a duration of 1 millisecond (ms) or less. Thus, in at least one embodiment, power, and thus, brightness, is reduced to LEDs 404, 406, and 408 in accordance with a time division power modulation algorithm for 1 ms or less, and light sensor 420 senses light whose brightness is reduced for 1 ms or less and generates sense signal SEN₁ to indicate the brightness of light 422 received by light sensor 420. In at least one embodiment, light sensor 420 is any commercially available photosensitive transistor-based or diode-based light sensor that can detect brightness of light and generate sense signal SEN₁. The particular light sensor 420 is a matter of design choice. Controller 412 includes a time division module 424. As subsequently explained in more detail, time division module 424 in conjunction with LED drivers 414, 416, and 418 selectively modulates drive currents i_{LED}_{_{—}}_{R}, i_{LED}_{_{—}}_{G}, and i_{LED}_{_{—}}_{B} in accordance with a time division algorithm that allows controller 412 to determine the individual brightness of LEDs 404, 406, and 408. By determining the individual brightness of LEDs 404, 406, and 408, in at least one embodiment, controller 412 individually adjusts drive currents i_{LED}_{_{—}}_{R}, i_{LED}_{_{—}}_{G}, and i_{LED}_{_{—}}_{B} to obtain a target brightness of light emitted from respective LEDs 404, 406, and 408.

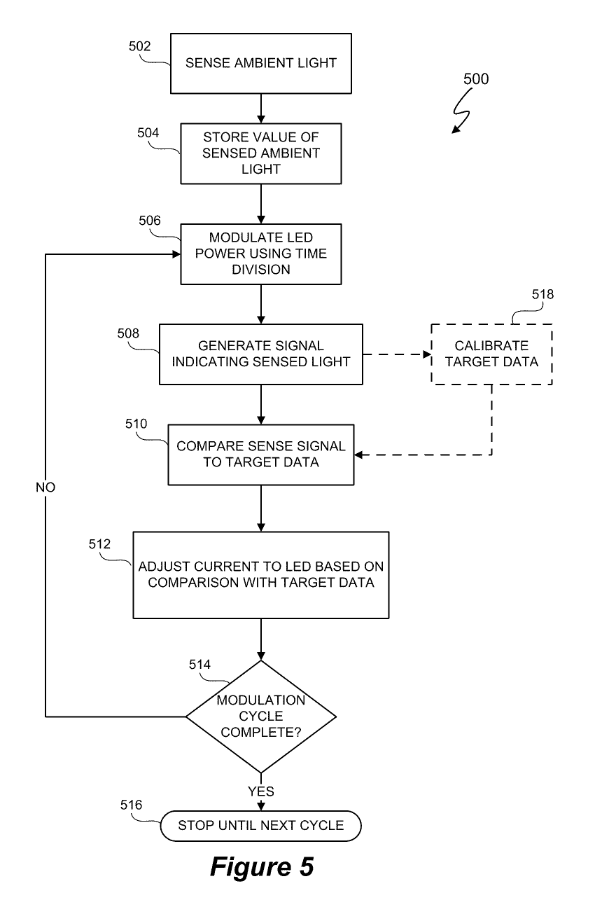

FIG. 5 depicts an exemplary time division sensing and LED adjustment algorithm 500 (referred to herein as the “time division and adjustment algorithm 500”) for sensing and adjusting the brightness of light emitted by LEDs 404, 406, and 408 of lighting system 400. In general, time division and adjustment algorithm 500 obtains a brightness value for ambient light and reduces the brightness of subgroups of LEDs 404, 406, and 408 over time, determines the brightness of each of LEDs 404, 406, and 408.

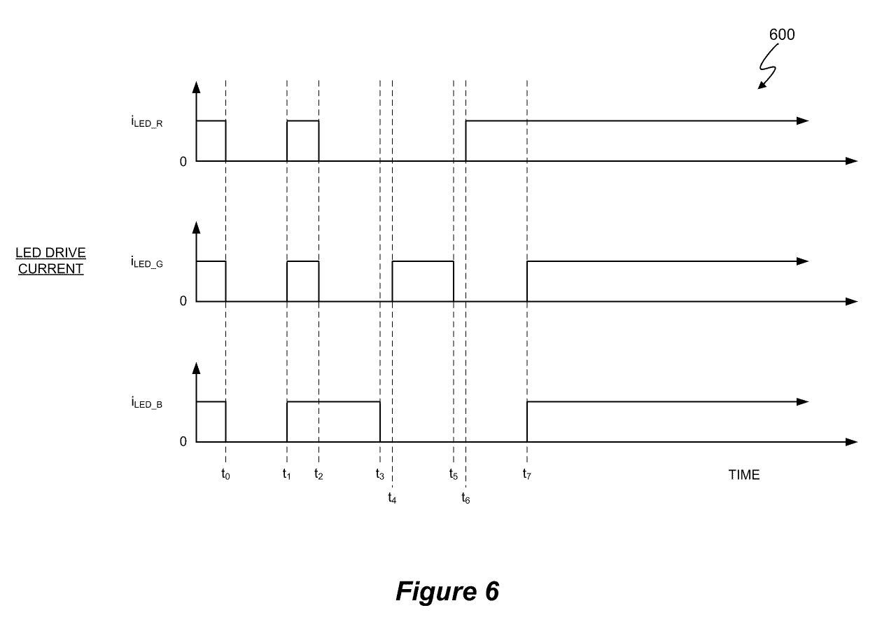

FIG. 6 depicts interspacing time division 600 for power modulation of LEDs 404, 406, and 408 (FIG. 4). In general, in interspacing time division 600, ambient light brightness is determined by reducing power to all of LEDs 404, 406, and 408, then current, and, thus, brightness, is reduced to two of LEDs 404, 406, and 408 at a time until the brightness of light from each of LEDs 404, 406, and 408 plus ambient light is sensed. Since the ambient light brightness is known, controller 412 can determine the individual brightness of light from each of LEDs 404, 406, and 408, compare each brightness to target data, and adjust the brightness of light from each of LEDs 404, 406, and 408 in accordance with results of the comparison. In at least one embodiment, the brightness of light from each of LEDs 404, 406, and 408 is adjusted by increasing or decreasing current to the LEDs 404, 406, and 408. Increasing current increases brightness, and decreasing current decreases brightness. In interspacing time division 600 power to the LEDs 404, 406, and 408 is reduced to zero. However, the particular amount of reduction is a matter of design choice.

Referring to FIGS. 4, 5, and 6, an exemplary operation of lighting system 400 involves time division and adjustment algorithm 500 and interspacing time division 600. In at least one embodiment, to sense the brightness of light emitted from each of LEDs 404, 406, and 408, in operation 502, lighting system 400 senses ambient light 423. In at least one embodiment, ambient light is light received by light sensor 420 that is not emitted by LEDs 404, 406, or 408. To sense only the ambient light, between times t₀ and t₁, LED drive currents i_{LED}_{_{—}}_{R}, i_{LED}_{_{—}}_{G}, and i_{LED}_{_{—}}_{B} are reduced to zero, thereby turning “off” LEDs 404, 406, or 408. Light sensor 420 senses the ambient light between times t₀ and t₁ and generates signal SEN₁, which is representative of the amount of ambient light 423 sensed by light sensor 420. In operation 504, controller 412 stores a value of sensed ambient light indicated by signal SEN₁. In operation 506, the time division module 424 modulates power to LEDs 404 and 406 by causing LED drivers 414 and 416 to reduce drive currents i_{LED}_{_{—}}_{R} and i_{LED}_{_{—}}_{G} to zero between times t₂ and t₃. Light sensor 420 senses the ambient light 423 and light emitted by LED 408 and, in operation 508, generates sense signal SEN₁ to indicate a brightness value of the sensed light.

As previously discussed, the human eye generally cannot perceive a reduction in brightness from a light source if the reduction has a duration of 1 millisecond (ms) or less. Thus, in at least one embodiment, each time division of power to LEDs 404, 406, and 408 as indicated by the LED drive current reduction times t₀-t₁, t₂-t₃, t₄-t₅, and t₆-t₇ in time division and adjustment algorithm 500 has a duration of 1 ms or less so that turning LEDs 404, 406, and 408 “off” and “on” during time division and adjustment algorithm 500 is imperceptible to a human.

In operation 510, controller 412 compares values of the sense signal to values of target data. The target data includes a target brightness value for sense signal SEN₁ in which the target brightness value is representative of a target brightness for the combination of the ambient light and light emitted from the blue LED 408. In operation 512, controller 412 adjusts the LED drive current i_{LED}_{_{—}}_{B} based on the comparison between the target brightness value and the brightness value indicated by sense signal SEN₁. If the comparison indicates that the brightness of LED 408 is low controller 412 increases the drive current i_{LED}_{_{—}}_{B}. If the comparison indicates that the brightness of LED 408 is high, controller 412 decreases the drive current i_{LED}_{_{—}}_{B}. Determining the amount and rate of change to drive current i_{LED}_{_{—}}_{B} is a matter of design choice. In at least one embodiment, the amount of drive current i_{LED}_{_{—}}_{B} change is determined based on the brightness-to-current relationship of LED 408 and the difference between the target brightness value and the brightness value of the sensed light indicated by sense signal SEN₁. In at least one embodiment, the rate of change for drive current i_{LED}_{_{—}}_{B} is low enough, e.g. less than 1 ms, to prevent an instantaneously noticeable change by a human.

Controller 412 adjusts the drive current i_{LED}_{_{—}}_{B} by adjusting control signal CS_{B} provided to lamp driver 418. In at least one embodiment, controller 412 generates control signal CS_{B} in accordance with Melanson II or Melanson III so that lamp driver 418 provides a desired drive current i_{LED}_{_{—}}_{B}.

In operation 514, controller 412 determines if operations 506-512 have been completed for all LEDs 404, 406, and 408. If not, the time division and adjustment algorithm 500 returns to operation 506 and repeats operations 506-512 for the next LED. In the currently described embodiment, in operation 506, time division module 424 reduces drive currents i_{LED}_{_{—}}_{R} and i_{LED}_{_{—}}_{B} to zero between times t₄ and t₅. Operations 508-512 then repeat to adjust drive current i_{LED}_{_{—}}_{G} as indicated by operation 512. Again, in operation 514, controller 412 determines if operations 506-512 have been completed for all LEDs 404, 406, and 408. In the currently described embodiment, in operation 506, time division module 424 reduces drive currents i_{LED}_{_{—}}_{G} and i_{LED}_{_{—}}_{B} to zero between times t₆ and t₇. Operations 508-512 then repeat to adjust drive current i_{LED}_{_{—}}_{R} as indicated by operation 512. After performing operations 508-512 for LEDs 404, 406, and 408, time division and adjustment algorithm 500 proceeds from operation 514 to operation 516. Operation 516 causes time division and adjustment algorithm 500 to stop until the next cycle. The next cycle repeats operations 502-516 as previously described to reevaluate the brightness of light from LEDs 404, 406, and 408.

The frequency of repeating time division and adjustment algorithm 500 is a matter of design choice and can be, for example, on the order of one or more seconds, one or more minutes, one or more hours, or one or more days. In at least one embodiment, time division and adjustment algorithm 500 is repeated every second. In at least one embodiment, time division and adjustment algorithm 500 is repeated often enough to sense changes in the ambient light and changes in the brightness of LEDs 404, 406, and 408 so that the brightness of light 426 exiting diffuser 428 is a constant or at least approximately constant value. Additionally, the timing between each period of power modulation, e.g. between times t₁ and t₂, t₃ and t4, and so on is a matter of design choice. The particular choice is, for example, long enough to perform operations 506-514 for an LED before repeating operations 506-514 for the next LED.

In at least one embodiment, the brightness of only a subset of LEDs 404, 406, and 408 are considered during operations 506-512. For example, if the red LED 404 is assumed to maintain a relatively constant brightness over time, then the modulation of power of LEDs 406 and 408 between times t₆ and t₇ in operation 506 and subsequent processing in operations 508-512 for LED 404 is not performed. Additionally, the amount of power reduction to LEDs 404, 406, and 408 in time division and adjustment algorithm 500 is a matter of design choice. Interspacing time division 600 depicts drive currents i_{LED}_{_{—}}_{R}, i_{LED}_{_{—}}_{G}, and i_{LED}_{_{—}}_{B} reducing to zero during time division power modulation times. The reduction amount is a matter of design choice. In at least one embodiment, the drive currents i_{LED}_{_{—}}_{R}, i_{LED}_{_{—}}_{G}, and/or i_{LED}_{_{—}}_{B} are reduced a specific percentage between approximately 10% and 90%. By reducing the drive currents i_{LED}_{_{—}}_{R}, i_{LED}_{_{—}}_{G}, and/or i_{LED}_{_{—}}_{B} to a value less than a nominal value, controller 412 accounts for the brightness contribution of all LEDs 404, 406, and 408 to the brightness indicated by sense signal SEN₁ when determining the adjustment to be made in operation 512.

In at least one embodiment, LEDs 404, 406, and/or 408 each represent a single LED. In at least one embodiment, one, two, or all of LEDs 404, 406, and 408 represent a set of LEDs that includes multiple LEDs having the same spectrum. For example, in at least one embodiment, LED 404 represents multiple red LEDs, LED 406 represents multiple green LEDs, and LED 408 represents multiple blue LEDs. The time division and adjustment algorithm 500 applies regardless of the number of LEDs in LEDs 404, 406, and 408.

The time division and adjustment algorithm 500 also includes optional operation 518 to calibrate the target data. In at least one embodiment, light sensor 420 is sensitive to temperature changes, which affects accuracy of the value provided for sense signal SEN₁. For example, in at least one embodiment, as the temperature of light sensor 420 increases, the value of sense signal SEN₁ changes for the same brightness level of light 422 received by light sensor 420. However, in at least one embodiment, the relationship between temperature changes of light sensor 420 and sense signal SEN₁ is known. In at least one embodiment, light sensor 420 provides temperature information to controller 412, or controller 412 senses the temperature in or near light sensor 420. Using this relationship, controller 412 accordingly calibrates the target data to compensate for effects of temperature on the accuracy of the values for sense signal SEN₁. In at least one embodiment, the light sensor 420 is self-compensating for temperature changes, thus, eliminating a need for optional operation 518. In at least one embodiment, temperature effects on the accuracy of values for sense signal SEN₁ are either negligible or not considered in time division and adjustment algorithm 500. The target data can also be adjusted to compensate for operating characteristics associated with light sensor 420. For example, in at least one embodiment, the reception by broad spectrum light sensor 420 is not uniform across the spectrum. The target data can be adjusted to account for the non-uniformity. In at least one embodiment, the adjustment is made during a calibration test by a manufacturer or distributor of lamp 402.

The time division and adjustment algorithm 500 represents one embodiment of a time division and adjustment algorithm that can be used to sense and, if appropriate, adjust the brightness of one or more LEDs in lighting system 400. The number of time division and adjustment algorithms that can be used by lighting system 400 is virtually limitless. For example, operations 506 and 508 can be executed for each of LEDs 404, 406, and 408, the sense signal SEN₁ stored for each of LEDs 404, 406, and 408, and operations 510 and 512 repeated for each of LEDs 404, 406, and 408. Additionally, the time intervals for reduction of power, such as between t₂ and t₁, t₄ and t₃, and so on of time division power modulation in interspacing time division 600 is a matter of design choice, and the range of power reductions is a matter of design choice. In at least one embodiment, the time intervals for reduction of power are less than an amount of time for a human to perceive a reduction in power by perceiving a change in brightness of the lighting system 400.

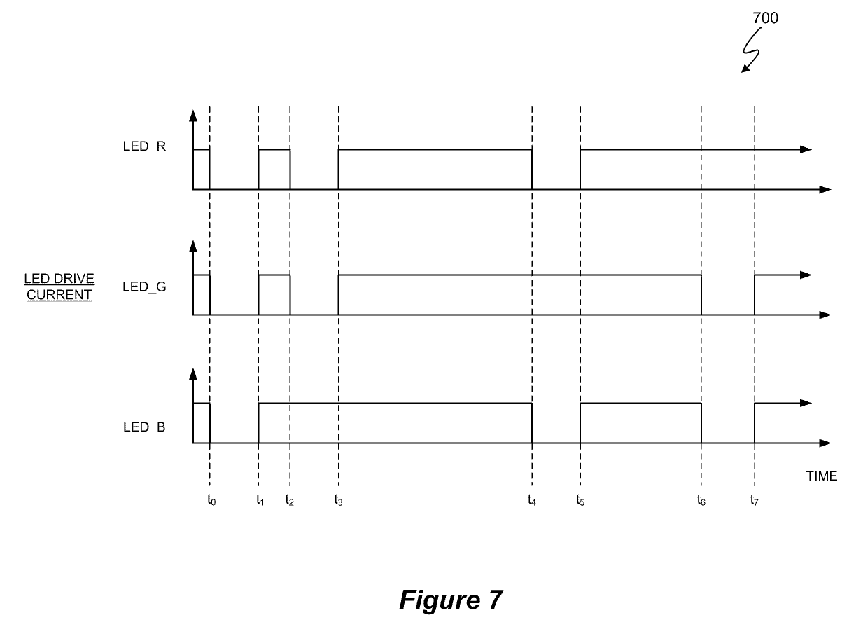

FIG. 7 depicts an LED current drive timing diagram 700. Timing diagram 700 illustrates interspersed time division, which represents another embodiment of a timing division power modulation scheme. Timing diagram 700 is similar to interspacing time division 600 except that the timing between reductions of power for different LEDs is clearly shown as interspersed over time. Time division and adjustment algorithm 500 works identically with interspersed time division 700 as time division and adjustment algorithm 500 works with interspacing time division 600. Using interspersed time division 700 spreads out the times between reductions in drive currents i_{LED}_{_{—}}_{R}, i_{LED}_{_{—}}_{G}, and i_{LED}_{_{—}}_{B}, thereby reducing the perceptibility of altering the brightness of light 426 during execution of time division and adjustment algorithm 500.

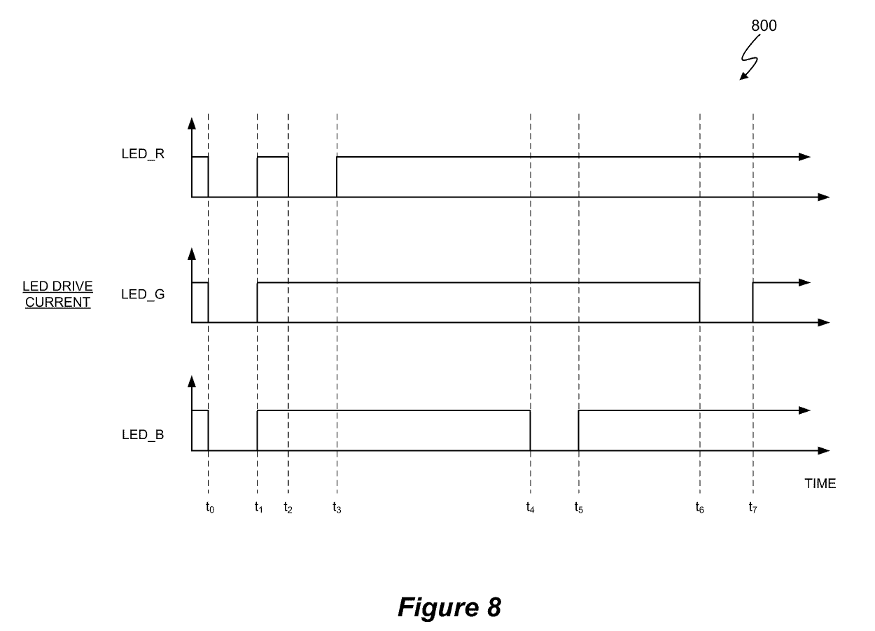

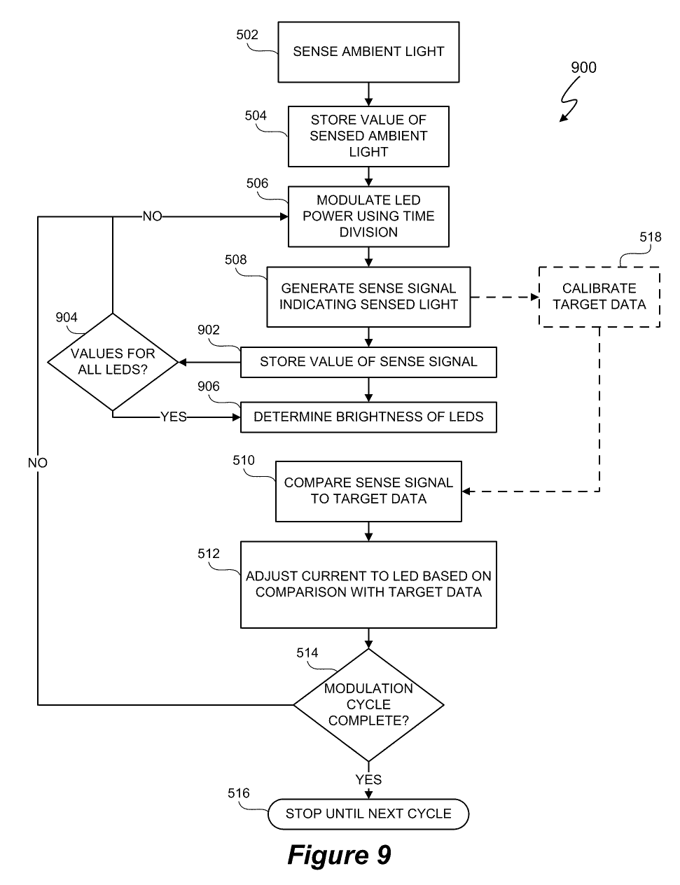

FIG. 8 depicts an LED current drive timing diagram 800. Timing diagram 800 illustrates unitary time division, which represents yet another embodiment of a timing division power modulation scheme. Unitary time division in timing diagram 800 reduces current to LEDs 404, 406, and 408 one at a time during respective periods t₂-t₃, t₆-t₇, and t₄-t₅. FIG. 9 depicts a time division and adjustment algorithm 900 for implementing unitary time division. In at least one embodiment, in order to utilize unitary time division, time division and adjustment algorithm 500 is modified to, for example, include operations 902-906. In operation 506, time division module 424 modulates power to LEDs 404, 406, and 408 in accordance with LED current drive timing diagram 800. Operation 902 stores each value of sense signal SEN₁ for each reduction in power to LEDs 404, 406, and 408 in a memory (not shown) within, or accessible to, controller 412. Sense signal SEN₁ is generated in operation 508 for a brightness levels sensed during time t₂-t₃. Operation 904 causes operations 506, 508, and 902 to repeat until a sense signal SEN₁ is generated in operation 508 for brightness levels sensed during times t₆-t₇ and t₄-t₅.

Once a brightness level has been determined during each of power modulation periods t₂-t₃, t₆-t₇, and t₄-t₅, controller 412 determines in operation 906 the brightness of each of LEDs 404, 406, and 408. Each stored value of sense signal SEN₁ represents the brightness of the ambient light and the contribution of two of the LEDs 404, 406, and 408 as set forth in Equation [1]:

SEN₁=BAL+BLEDx+BLEDy [1],

where BAL=the brightness of the ambient light, and BLEDx and BLEDy equal the respective brightness contributions of the two LEDs of LEDs 404, 406, and 408 whose power is not reduced in operation 506. Since the brightness of the ambient light, BAL, is known from operations 502 and 504, in at least one embodiment, controller 412 uses a multi-variable, linear equation solution process to solve for the three values of sense signal SEN₁ stored in operation 902 using three instances of Equation [1]. The particular linear equation solution process is a matter of design choice. For example, at time t₃:

SEN₁=BAL+BLED406+BLED408 [2],

at time t₆:

SEN₁=BAL+BLED404+BLED406 [3],

at time t₇:

SEN₁=BAL+BLED404+BLED408 [4].

Since the value of BAL and SEN₁ is known, Equation [2] can be solved for BLED406 in terms of BLED408 and substituted into Equation [3]. After the substitution, Equation [3] can be solved in terms of BLED408 and substituted into Equation [4]. After substitution, Equation [4] can be solved for the value of BLED408. From the value of BLED408, BLED406 and BLED404 can then be solved from Equation [2] then Equation [3].

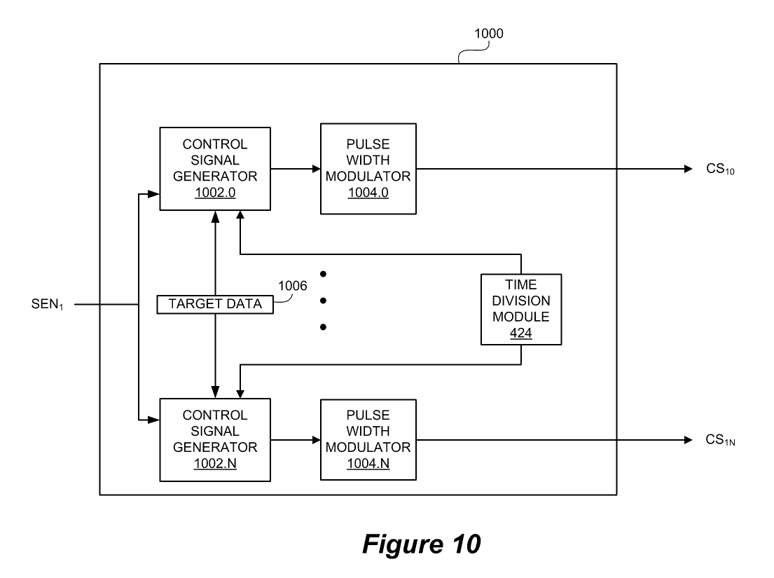

FIG. 10 depicts controller 1000, which represents one embodiment of controller 412. Controller 1000 includes control signal generators 1002.0-1002.N and pulse width modulators 1004.0-1004.N for generation of respective control signals CS₁₀ and CS_{1N}. In at least one embodiment, each of control signal generators 1002.0-1002.N and pulse width modulators 1004.0-1004.N operate in accordance with time division and adjustment algorithm 500 or time division and adjustment algorithm 900 to determine the brightness of light of at least two LEDs having different spectra and adjust the brightness in accordance with a comparison to values of target data 1006 representing a target brightness of the LEDs. Generally adjusting current to LEDs using pulse width modulated control signals control signals CS₁₀ and CS_{1N} is illustratively described in Melanson II. In at least one embodiment, control signal generators 1002.0-1002.N cause control signals CS₁₀ and CS_{1N} to have no pulse during sensing of ambient light in operation 502 (FIGS. 5 and 9).

Thus, a lighting system includes time division light output sensing and adjustment for different spectra light emitting diodes (LEDs). In at least one embodiment, the time division light output sensing and adjustment allows the lighting system to individually adjust the brightness of LEDs to account for ambient light and changes in brightness of the LEDs.

Although the present invention has been described in detail, it should be understood that various changes, substitutions and alterations can be made hereto without departing from the spirit and scope of the invention as defined by the appended claims.

What is claimed is:

1. An apparatus comprising:
a controller configured to at least adjust brightness of light emitted from a first light emitting diode (LED) and adjust brightness of light emitted from a second LED, wherein, during operation of the controller, the light emitted from the first LED has a different spectrum than the light emitted from the second LED and the controller is further configured to at least:
i. receive a first signal indicating a brightness of received light at a first time;
ii. receive a second signal indicating a brightness of the received light at a second time, wherein a relative contribution to the brightness from the first and second LEDs is different for the first and second times;
iii. determine the brightness of light emitted from the first LED and the brightness of light emitted from the second LED using information from the signals; and
iv. adjust the brightness of the light emitted from the first LED and the brightness of the light emitted from the second LED in accordance with one or more brightness related target values.

2. The apparatus of claim 1 wherein:
to receive a first signal indicating a brightness of received light at a first time comprises to receive the first signal from at least a first sensor indicating a brightness of received light at a first time; and
receive a second signal indicating a brightness of the received light at a second time comprises to receive the second signal from the least one sensor indicating a brightness of the received light at a second time.

3. The apparatus of claim 1 wherein:
to receive a first signal indicating a brightness of received light at a first time comprises to receive the first signal from at least a first sensor indicating a brightness of received light at a first time; and
to receive a second signal indicating a brightness of the received light at a second time comprises to receive the second signal from at least a second sensor indicating a brightness of the received light at a second time.

4. The apparatus of claim 1 wherein the first and second LEDs are members of groups consisting of: red and green, red and yellow, amber and blue, green and blue, and red and blue.

5. The apparatus of claim 1 wherein the first LED is a member of a first set of multiple LEDs having approximately identical spectra and the second LED is a member of a second set of multiple LEDs having approximately identical spectra.

6. The apparatus of claim 1 wherein the controller is further configured to:
adjust the brightness of the light emitted from the first and second LEDs to compensate for at least one of (a) LED temperature changes and (b) light output changes over time.

7. The apparatus of claim 1 wherein at least one of the sensors is a broad spectrum light sensor.

8. The apparatus of claim 7 wherein a single, broad spectrum sensor provides the signals indicating brightness at the first and second times.

9. The apparatus of claim 1 wherein the controller is further configured to:
modulate current to the first and second LEDs so that the relative contribution to the brightness of the light received by the one or more sensors is different for the first and second times.

10. The apparatus of claim 9 wherein to modulate current to the first and second LEDs comprises:
reducing current to the first LED to zero while providing current to the second LED during the first time; and
reducing current to the second LED to zero while providing current to the first LED during the second time.

11. The apparatus of claim 9 wherein to modulate current to the first and second LEDs comprises:
providing less average current to the first LED than the second LED during the first time and providing less average current to the first LED than the second LED during the first time.

12. The apparatus of claim 9 wherein to modulate current to the first and second LEDs comprises:
modulating current to the first and second LEDs during sequential times.

13. The apparatus of claim 9 wherein to modulate current to the first and second LEDs comprises:
interspersing reductions in current to the first and second LEDs over time.

14. The apparatus of claim 1 wherein the controller is further configured to adjust brightness of light emitted from at least a third LED, wherein during operation of the controller, the light emitted from the third LED has a different spectrum than light emitted from the first and second LEDs, wherein the controller is further configured to at least:
i. receive a third signal indicating a brightness of the received light at a third time, wherein a relative contribution to the brightness from the first, second, and third LEDs is different for the first, second, and third times;
ii. determine the brightness of light emitted from the first LED, the brightness of light emitted from the second LED, and the brightness of light emitted from the third LED using information from the signals; and
iii. adjust the brightness of the light emitted from the first LED, the brightness of the light emitted from the second LED, and the brightness of light emitted from the third LED in accordance with one or more brightness related target values.

15. The apparatus of claim 14 wherein the first LED is a red LED, the second LED is a green LED, and the third LED is a blue LED.

16. An apparatus comprising:
a lamp having at least a first light emitting diode (LED) and a second LED, wherein, during operation, light output of the first LED has a different spectrum than light output from the second LED;
one or more sensors to sense brightness of received light; and
a controller coupled to the lamp and the sensor, wherein the controller is configured to at least:
i. receive a first signal from at least one of the sensors indicating a brightness of the received light at a first time;
ii. receive a second signal from at least one of the sensors indicating a brightness of the received light at a second time, wherein a relative contribution to the brightness from the first and second LEDs is different for the first and second times;
iii. determine the brightness of light emitted from the first LED and the brightness of light emitted from the second LED using information from the signals; and
iv. adjust the brightness of the light emitted from the first LED and the brightness of the light emitted from the second LED in accordance with one or more brightness related target values.

17. The apparatus of claim 16 wherein the first and second LEDs are members of groups consisting of: red and green, red and yellow, amber and blue, green and blue, and red and blue.

18. The apparatus of claim 16 wherein the first LED is a member of a first set of multiple LEDs having approximately identical spectra and the second LED is a member of a second set of multiple LEDs having approximately identical spectra.

19. The apparatus of claim 16 wherein the controller is further configured to:
adjust the brightness of the first and second LEDs to compensate for at one of (a) LED temperature changes and (b) light output changes over time.

20. The apparatus of claim 16 wherein at least one of the sensors is a broad spectrum sensor.

21. The apparatus of claim 20 wherein a single, broad spectrum sensor provides the signals indicating brightness at the first and second times.

22. The apparatus of claim 16 wherein the controller is further configured to:
modulate current to the first and second LEDs so that the relative contribution to the brightness of the light received by the one or more sensors is different for the first and second times.

23. The apparatus of claim 22 wherein to modulate current to the first and second LEDs comprises:
reducing current to the first LED to zero while providing current to the second LED during the first time; and
reducing current to the second LED to zero while providing current to the first LED during the second time.

24. The apparatus of claim 22 wherein to modulate current to the first and second LEDs comprises:
providing less average current to the first LED than the second LED during the first time and providing less average current to the first LED than the second LED during the first time.

25. The apparatus of claim 22 wherein to modulate current to the first and second LEDs comprises:
modulating current to the first and second LEDs during sequential times.

26. The apparatus of claim 22 wherein to modulate current to the first and second LEDs comprises:
interspersing reductions in current to the first and second LEDs over time.

27. The apparatus of claim 16 wherein the lamp includes at least a third LED, wherein during operation of the controller, the light emitted from the third LED has a different spectrum than light emitted from the first and second LEDs, wherein the controller is further configured to at least:
i. receive a third signal indicating a brightness of the received light at a third time, wherein a relative contribution to the brightness from the first, second, and third LEDs is different for the first, second, and third times;
ii. determine the brightness of light emitted from the first LED, the brightness of light emitted from the second LED, and the brightness of light emitted from the third LED using information from the signals; and
iii. adjust the brightness of the light emitted from the first LED, the brightness of the light emitted from the second LED, and the brightness of light emitted from the third LED in accordance with one or more brightness related target values.

28. The apparatus of claim 27 wherein the first LED is a red LED, the second LED is a green LED, and the third LED is a blue LED.

29. A method to at least adjust brightness of light emitted from a first light emitting diode (LED) and adjust brightness of light emitted from a second LED, wherein the light emitted from the first LED has a different spectrum than the light emitted from the second LED, the method comprising:
receiving a first signal indicating a brightness of received light at a first time;
receiving a second signal indicating a brightness of the received light at a second time, wherein a relative contribution to the brightness from the first and second LEDs is different for the first and second times;
determining the brightness of light emitted from the first LED and the brightness of light emitted from the second LED using information from the signals; and
adjusting the brightness of the light emitted from the first LED and the brightness of the light emitted from the second LED in accordance with one or more brightness related target values.

30. The method of claim 29 wherein the first and second LEDs are members of groups consisting of: red and green, red and yellow, amber and blue, green and blue, and red and blue.

31. The method of claim 29 wherein the first LED is a member of a first set of multiple LEDs having approximately identical spectra and the second LED is a member of a second set of multiple LEDs having approximately identical spectra.

32. The method of claim 29 further comprising:
adjusting the brightness of the light emitted from the first and second LEDs to compensate for at one of (a) LED temperature changes and (b) light output changes over time.

33. The method of claim 29 further comprising:
receiving the signal indicating the brightness of received light at the first and second times from a single broad spectrum sensor.

34. The method of claim 29 further comprising:
receiving the signal indicating the brightness of received light at the first and second times from one or more sensors; and
modulating current to the first and second LEDs so that the relative contribution to the brightness of the light received by the one or more sensors is different for the first and second times.

35. The method of claim 34 wherein modulating current to the first and second LEDs comprises:
reducing current to the first LED to zero while providing current to the second LED during the first time; and
reducing current to the second LED to zero while providing current to the first LED during the second time.

36. The method of claim 34 wherein modulating current to the first and second LEDs comprises:
providing less power to the first LED than the second LED during the first time and providing less power to the first LED than the second LED during the first time.

37. The method of claim 34 wherein modulating current to the first and second LEDs comprises:
modulating power to the first and second LEDs during sequential times.

38. The method of claim 34 wherein modulating current to the first and second LEDs comprises:
interspersing reductions in power to the first and second LEDs over time.

39. The method of claim 29 wherein the lamp includes at least a third LED, wherein during operation of the controller, light output of the third LED has a different spectrum than light output from the first and second LEDs, the method further comprising:
receiving a third signal indicating a brightness of the received light at a third time, wherein a relative contribution to the brightness from the first, second, and third LEDs is different for the first, second, and third times;
determining the brightness of light emitted from the first LED, the brightness of light emitted from the second LED, and the brightness of light emitted from the third LED using information from the signals; and
adjusting the brightness of the light emitted from the first LED, the brightness of the light emitted from the second LED, and the brightness of light emitted from the third LED in accordance with one or more brightness related target values.

40. The method of claim 39 wherein the first LED is a red LED, the second LED is a green LED, and the third LED is a blue LED.
